(19) United States
(12) Patent Application Publication
(10) Pub. No.: US 2021/0386033 A1
(43) Pub. Date: Dec. 16, 2021

(54) Window Pet Enclosure

(71) Applicant: Rayne Medina, El Prado, NM (US)

(72) Inventor: Rayne Medina, El Prado, NM (US)

(21) Appl. No.: 17/346,692

(22) Filed: Jun. 14, 2021

Related U.S. Application Data
(60) Provisional application No. 63/039,858, filed on Jun. 16, 2020.

(51) Int. Cl. A01K 1/03; A01K 1/035; A01K 1/01

(52) U.S. Cl. CPC A01K 1/03; A01K 1/0107; A01K 1/035

(57) ABSTRACT

A window pet enclosure is provided. The device includes a housing having a base, wherein a frame extends from the base. The frame includes a plurality of supports affixed to each corner of the base. An upper wall is affixed to a distal end of each of the plurality of supports. A plurality of sidewalk is disposed between the plurality of supports. An opening is defined through a rear sidewall of the plurality of sidewalk. A mounting bracket is disposed on the frame on the rear sidewall, wherein the housing is removably securable to an exterior of a window opening via the mounting bracket. In some embodiments, the plurality of supports includes a plurality of interlocking legs having at least one tab and at least one aperture therein, wherein the aperture is dimensioned to frictionally engage the tab to secure the plurality of interlocking legs together in various configurations.

### CROSS REFERENCE TO RELATED APPLICATIONS

This application claims the benefit of U.S. Provisional Application No. 63/039,858 filed on Jun. 16, 2020. The above identified patent application is herein incorporated by reference in its entirety to provide continuity of disclosure.

### BACKGROUND OF THE INVENTION

The present invention relates to pet enclosures. More particularly, the present invention pertains to a pet enclosure securable to an exterior of a building window to provide pets with fresh air while ensuring the pet's safety.

Many individuals own pets which are unable to freely experience the outside world. For example, cats are often kept indoors through their entire lives as they may run away or hide instinctually once outdoors. Additionally, In some areas, the wildlife may be dangerous and attack pets that are outdoors. Similarly, other pets may be unable to leave the house due to an owner's medical or mobility issues, which can prevent the owner from taking the pet out for a walk. However, in these cases, the individual may still wish for their pet to experience the outdoors in a safe and controlled manner. Typically, indoor pets are limited to refracted sunlight coming into the home through windows, however this does not allow the pet to experience fresh air. Therefore, a pet enclosure securable to a home that can expose the pet to the outdoors while preventing the pet from leaving the area or being harmed by wildlife is desired.

In light of the devices disclosed in the known art, it is submitted that the present invention substantially diverges in design elements from the known art and consequently it is clear that there is a need in the art for an improvement to existing pet enclosures. In this regard, the instant invention substantially fulfills these needs.

### SUMMARY OF THE INVENTION

In view of the foregoing disadvantages inherent in the known types of pet enclosures now present in the known art, the present invention provides a pet enclosure securable to an exterior of a window wherein the same can be utilized for providing convenience for the user when providing pets with a play area exposed to fresh air.

The present system comprises a housing having a base, wherein the frame extends from the base. The frame comprises a plurality of supports affixed to each corner of the base. An upper wall is affixed to a distal end of each of the plurality of supports. A plurality of sidewalls is disposed between the plurality of supports. An opening is defined through a rear sidewall of the plurality of sidewalls. A mounting bracket is disposed on the frame adjacent to the rear sidewall, wherein the housing is removably securable to an exterior of a window opening via the mounting bracket. In some embodiments, each of the plurality of supports comprises a plurality of interlocking legs, wherein each of the plurality of interlocking legs includes at least one tab and at least one aperture therein, wherein the aperture is dimensioned to frictionally engage the tab to secure the plurality of interlocking legs together to define a variety of housing interior configurations.

In some embodiments, a plurality of shelves is removably securable to the frame on an interior of the housing. In another embodiment, the plurality of shelves includes a fastener on a rear side thereof, wherein the fastener is removably securable within a securement aperture disposed through the plurality of supports. In other embodiments, a rope is affixed to a lower side of at least one of the plurality of shelves. In yet another embodiment, a door is pivotally affixed to the base, wherein the door provides access to an interior of the housing through a lateral sidewall of the plurality of sidewalls. In some embodiments, the plurality of sidewalk comprises a mesh material. In another embodiment, the opening is disposed through the rear sidewall in an elevated position relative to the base, such that the base is disposed below a plane of the window opening when the housing is secured thereto. In other embodiments, a shade is disposed on a roller on an upper end of at least one sidewall of the plurality of sidewalls, wherein the shade is selectively movable between an extended position extending along a height of the sidewall and a retracted position about the roller. In yet another embodiment, the roller is spring-biased to automatically retract the shade, such that the shade is biased towards the retracted position. In some embodiments, a plurality of accessories is removably securable within the housing, wherein the plurality of accessories is selected from a group consisting of: a staircase, a ramp, and a litter box.

### BRIEF DESCRIPTION OF THE DRAWINGS

Although the characteristic, features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a rear perspective view of an embodiment of the window pet enclosure.

FIG. 2 shows an exploded view of the plurality of shelves of an embodiment of the window pet enclosure.

FIG. 3 shows a close-up view of the door and accessories of an embodiment of the window pet enclosure.

FIG. 4 shows an exploded view of a modular embodiment of the window pet enclosure.

FIG. 5 shows a perspective view of an embodiment of the window pet enclosure in use.

### DETAILED DESCRIPTION OF THE INVENTION

Reference is made herein to the attached drawings. Like reference numerals are used throughout the drawings to depict like or similar elements of the window pet enclosure. The figures are intended for representative purposes only and should not be considered to be limiting in any respect. For the purposes of brevity, the following description refers to the use of the window pet enclosure as a feline pet enclosure, however, it should be noted that the window pet enclosure can similarly be outfitted with accessories appropriate for and to be utilized with other pets, such as dogs, birds, or the like.

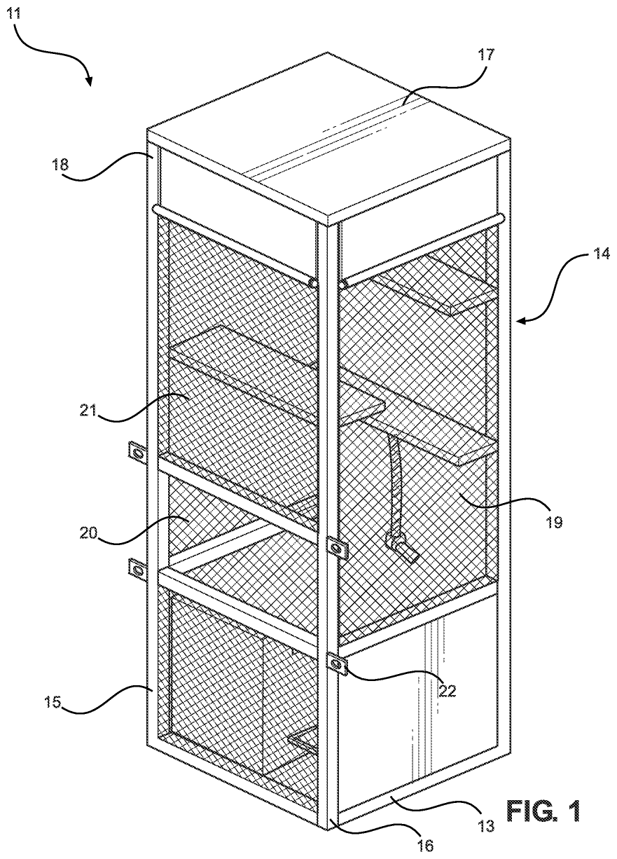

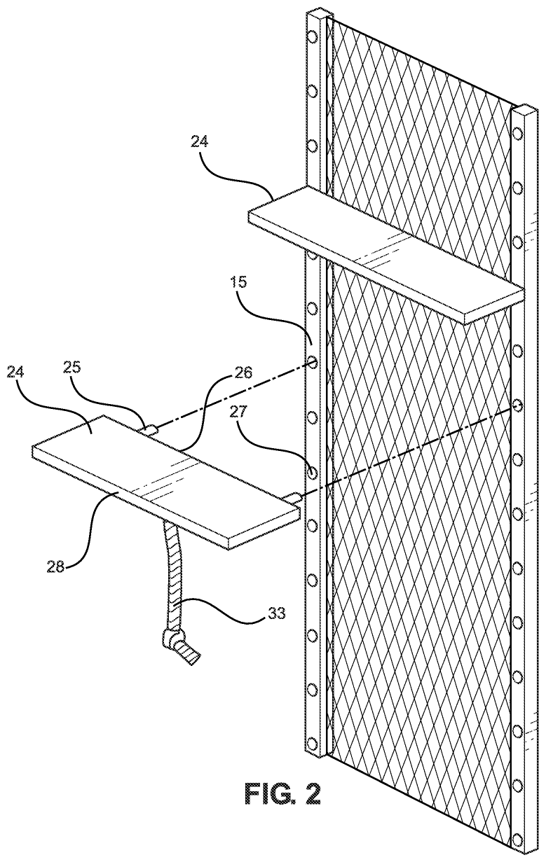

Referring now to FIG. 1, there is shown a rear perspective view of an embodiment of the window pet enclosure. The window pet enclosure 11 comprises a housing having a base 13 and a frame 14 affixed thereto. The frame 14 comprises a plurality of supports 15 extending from each corner 16 of the base 13. An upper wall 17 is disposed opposite the base 13 affixed to a distal end 18 of each of the plurality of supports 15. The upper wall 17 comprises a solid material similar to the base 13, such that precipitation or other environmental effects are prevented from passing therethrough. A plurality of sidewalls 19 are defined between adjacent supports of the plurality of supports 15, defining an interior volume therebetween. In the illustrated embodiment, the plurality of sidewalls 19 comprise a mesh material, wherein the mesh includes a plurality of small openings therethrough to allow airflow to expose pets within the housing to fresh air. The mesh material is contemplated to comprise a flexible fabric material, such that the plurality of sidewalls 19 flex when a pet lays against the sidewalk to increase the pet's comfort. Alternatively, the plurality of sidewalls 19 are contemplated to comprise a rigid material to increase the structural integrity of the window pet enclosure 11, as well as providing an alternate stable mounting location for a plurality of shelves (as shown in FIG. 2, 24).

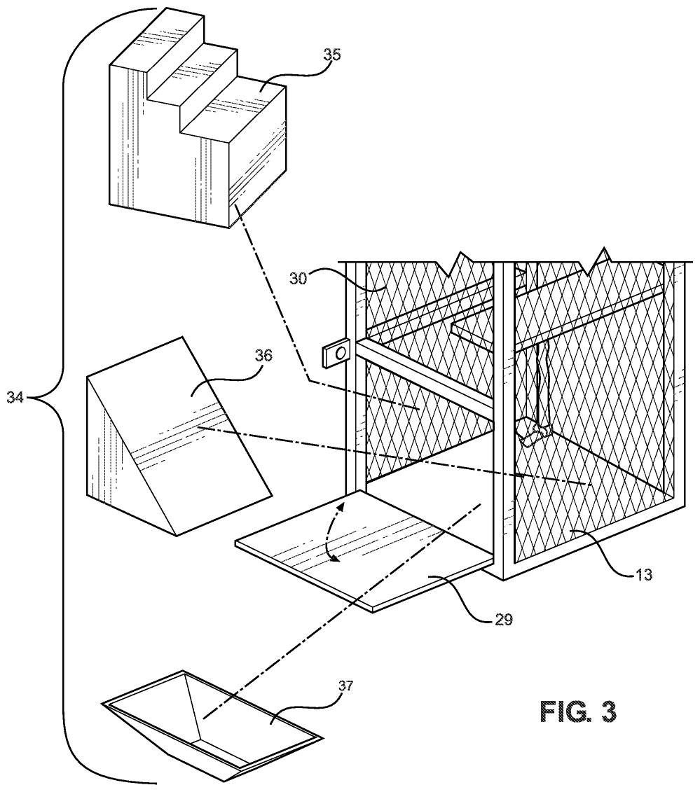

An opening 20 is defined through a rear sidewall 21 of the plurality of sidewalk 19, wherein the opening 20 provides access to the interior volume of the window pet enclosure 11. In the illustrated embodiment, the opening 20 is defined by perpendicularly support elements extending from a pair of opposing supports of the plurality of supports 15. In this manner, the opening 20 is maintained in a rigid open position while simultaneously increasing the structural integrity of the rear sidewall 21. The opening 20 is securable over an existing window opening, allowing an indoor pet to exit through the window opening into the window pet enclosure 11. In the illustrated embodiment, the base 13 is disposed at a lower height relative to the opening 20 providing a sunken location within the window pet enclosure 11 for storage of a variety of objects, such as a litter box (as shown in FIG. 3, 37).

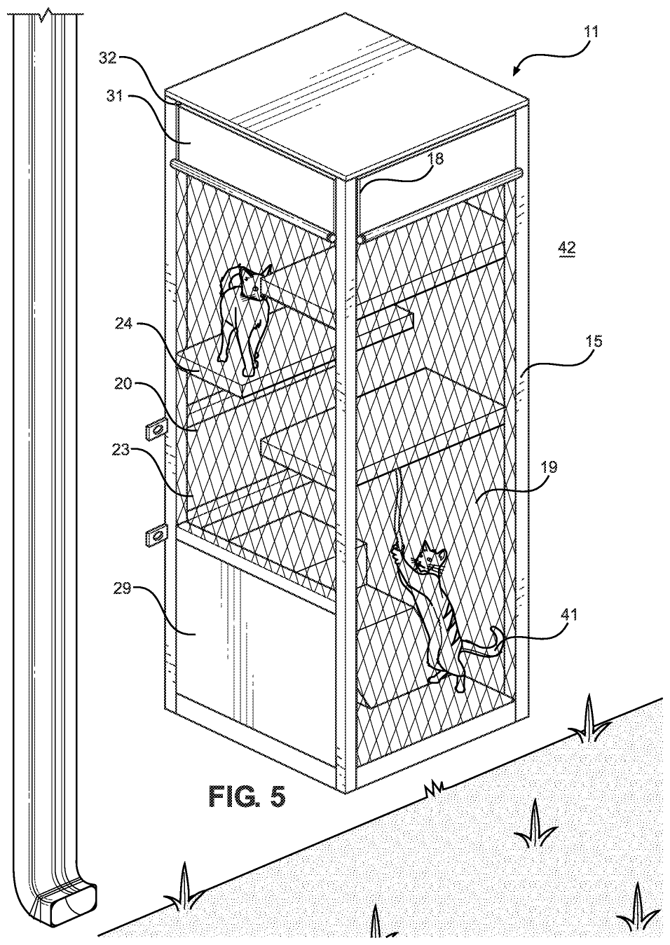

The rear sidewall 21 is removably securable to a building (as shown in FIG. 5, 42) via at least one mounting bracket 22 affixed to the plurality of supports 15 of the rear sidewall 21. In the illustrated embodiments, the mounting brackets 22 comprise a plate having an aperture therethrough, wherein the aperture is dimensioned to receive a fastener therethrough. In this manner, the user can insert a fastener through the aperture to secure the mounting bracket 22 to an existing window frame. In the shown embodiment, the mounting brackets 22 are isolated to a portion of the frame 14 adjacent to the opening 20 to facilitate securement to an existing window frame, however, in alternate embodiments, the mounting brackets 22 extend along a height of the rear sidewall 22, such that the window pet enclosure 11 is more securely affixed to the building during use. In such embodiments, the mounting brackets 22 disposed along the plurality of supports 15 away from the opening 20 comprise a structure configured to secure to aluminum siding or other common building exteriors. In this manner, it is contemplated that the mounting brackets 22 adjacent to the opening 20 comprise a different configuration than the mounting brackets 22 along a remainder of the plurality of supports 15 to facilitate securement to differing portions of a building.

Referring now to FIG. 2, there is shown an exploded view of the plurality of shelves of an embodiment of the window pet enclosure. In the illustrated embodiment, a plurality of shelves 24 are removably securable to the plurality of supports 15. The plurality of shelves 24 are selectively moveable along the plurality of supports 15 to allow a user to customize the position of each shelf as desired for a particular pet. For example, larger pets may require more space between adjacent shelves of the plurality of shelves 24 to maneuver within the window pet enclosure. The plurality of shelves 24 can be secured to opposing sidewalk to define a staggered ladder to allow pets to climb the height of the enclosure. In the illustrated embodiment, each shelf includes a fastener 25 affixed to a rear side 26 thereof, wherein the fastener 25 is removably securable within a securement aperture 27 defined within the plurality of supports 15. In some embodiments, the fasteners 25 removably secure via friction fit, whereas, in the shown embodiment, the fasteners 25 comprise hooks that secure within the securement apertures 27. In this manner, the weight of each shelf retains the fastener 25 within the securement aperture 27. In some embodiments, the fasteners 25 are securable within the openings defined by the mesh material of the plurality of sidewalls, such that the user is able to position each shelf as desired more precisely. In other embodiments, the plurality of shelves 24 are integrally affixed to the plurality of supports 15 at predefined locations. In the illustrated embodiment, a rope 33 is affixed to a lower side 28 of at least one shelf of the plurality of shelves 24, wherein the rope 33 is contemplated to operate as a toy or pet attractor. Alternate objects may similarly be secured to the lower side 28 to facilitate pet play within the enclosure, including objects impregnated with catnip or other pet attractants. In some embodiments, the rope 33 is removably securable to the lower side 28 to allow a user to replace the rope 33 with an alternate toy or pet attractor.

Referring now to FIG. 3, there is shown a close-up view of the door and accessories of an embodiment of the window pet enclosure. In the shown embodiment, a door 29 is pivotally affixed to the base 13 through a lateral sidewall 30 of the plurality of sidewalk, wherein the door 29 is selectively movable between an open position and a closed position, wherein the open position is defined when the door 29 is pivoted outwardly relative to the interior of the enclosure. In the open position, the door 29 provides access to the interior of the enclosure from a position exterior to the building upon which the enclosure is affixed. In this manner, the user can easily retrieve objects from the interior volume from an exterior location such that the user need not lift and maneuver objects on the base 13 through the building window opening. In some embodiments, the door 29 further comprises a handle or other gripping surface to facilitate movement of the door 29 between the open and closed positions. In the shown embodiment, an upper edge of the door 29 is aligned with a lower edge of the opening, such that objects having a height equivalent to the distance between the lower edge of the opening and the base 13 can be inserted through the open door 29.

In the illustrated embodiment, a plurality of accessories 34 are removably securable within the interior volume of the enclosure, wherein the plurality of accessories 34 are selected from a group consisting of a staircase 35, a ramp 36, and a litter box 37. In such embodiments, the plurality of accessories 34 comprise a variety of objects contemplated for use with cats, however, in alternate embodiments, the plurality of accessories 34 can further include alternate objects designed for use with other pets. In the illustrated embodiment, the staircase 35 and the ramp 36 comprise a height equivalent to a distance between the base 13 and the opening, such that a pet may utilize either the ramp 36 or the staircase 35 to aid in climbing from and exiting the enclosure through the window opening. The litter box 37 can be inserted through the open door 29 and rested on the base 13 to provide a convenient location for pets to relieve themselves. Upon soiling the litter box 37, the user can retrieve the litter box 37 from the interior via the door 29 to refresh the litter box 37.

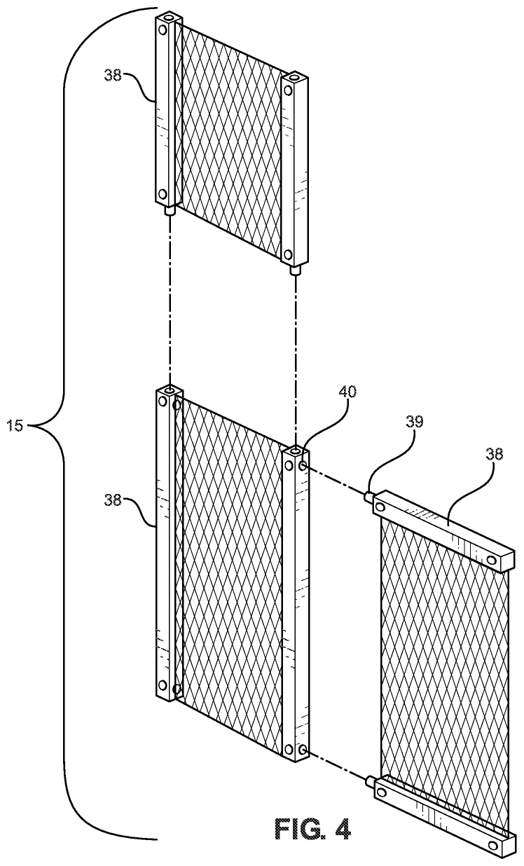

Referring now to FIG. 4, there is shown an exploded view of a modular embodiment of the window pet enclosure. In some embodiments, the frame of the window pet enclosure comprises a modular design allowing the user to assemble the window pet enclosure in various shapes and geometries to provide pets with various enclosure configurations. While the present disclosure describes one possible modular structure, alternate structures are also contemplated to achieve similar results. In the illustrated embodiment, the plurality of supports 15 comprise a plurality of interlocking legs 38 each having a tab 39 removably securable within an aperture 40 via frictional engagement. In the shown embodiment, the tab 39 extends from an end of each of the interlocking legs 38, such that the tab 39 can be inserted into an aperture 40 disposed within an opposing end of each interlocking leg 38 or an exterior surface of each interlocking leg 38, thereby allowing the user to assemble the window pet enclosure into a variety of configurations. In the illustrated embodiment, a pair of interlocking legs 38 are secured to an upper end of an adjacent interlocking leg 38 and a lateral side of the interlocking leg 38 to create a structural foundation in independent directions, allowing a user to define various polyomino configurations.

Referring now to FIG. 5, there is shown a perspective view of an embodiment of the window pet enclosure in use. In the illustrated embodiment, at least one shade 31 is operably affixed to a roller 32 disposed at the distal end 18 of each of the plurality of supports 15, The roller 32 is configured to selectively extend and retract the shade 31 along a length of at least one of the externally facing sidewalls of the plurality of sidewalls 19 to provide shade and a windbreak for pets within the window pet enclosure 11. In some embodiments, the roller 32 is configured to lock the shade 31 in a partially extended position, such that the user can selectively extend the shade 31 along a desired length to provide limited areas of shade within the window pet enclosure 11. In some such embodiments, the shade 31 is biased towards the retracted position, such that the roller 32 automatically retracts the shade 31 about the roller 32 when the lock is disengaged. In alternate embodiments, the roller 32 is remotely controllable to allow the shade 31 to be extended upon actuation of a separate control.

In one use, the window pet enclosure 11 can be secured to a building 42 such that the opening 20 is aligned with an existing window opening 23, thereby allowing pets 41 to enter the window pet enclosure 11 through the window opening 23. In some embodiments, the mounting brackets are secured to the window frame via fasteners, such as screws, nails, or the like. In other embodiments, the window pet enclosure 11 is further secured to the building 42 along the rear sidewall via building siding compatible mounting brackets. The user can further secure the plurality of shelves 24 within the window pet enclosure 11 to allow the pets 41 to rest on the plurality of shelves 24 at various heights within the window pet enclosure 11. Additional accessories can be inserted within the window pet enclosure 11 via the door 29 to allow the user to dean and maintain the interior volume, such as replacing or refilling litter in the litter box. Once secured to the building 42, pets 41 may enter the window pet enclosure 11 to experience fresh air and sunlight entering the interior volume through the mesh material of the plurality of sidewalk 19. Should the user wish to limit the air flow and sunlight entering the enclosure, the shade 31 can be lowered to extend partially or entirely along a length of the plurality of sidewalks 19. In this manner, the user can ensure one or more pets 41 have a comfortable and entertaining area exposed to the outdoors without risk of the pets 41 becoming lost or injured.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A window pet enclosure, comprising:
a housing having a base;
a frame extending from the base, wherein the frame comprises a plurality of supports affixed to each corner of the base;
an upper wall affixed to a distal end of each of the plurality of supports;
a plurality of sidewalk disposed between the plurality of supports;
an opening defined through a rear sidewall of the plurality of sidewalk;
a mounting bracket disposed on the frame adjacent to the rear sidewall; and
wherein the housing is removably securable to an exterior of a window opening via the mounting bracket.

2. The window pet enclosure of claim 1, further comprising a plurality of shelves removably securable to the frame on an interior of the housing.

3. The window pet enclosure of claim 2, wherein the plurality of shelves includes a fastener on a rear side thereof, wherein the fastener is removably securable within a securement aperture disposed through the plurality of supports.

4. The window pet enclosure of claim 2, further comprising a rope affixed to a lower side of at least one of the plurality of shelves.

5. The window pet enclosure of claim 1, further comprising a door pivotally affixed to the base, wherein the door provides access to an interior of the housing through a lateral sidewall of the plurality of sidewalk.

6. The window pet enclosure of claim 1, wherein the plurality of sidewalk comprises a mesh material.

7. The window pet enclosure of claim 1, wherein the opening is disposed through the rear sidewall in an elevated position relative to the base, such that the base is disposed below a plane of the window opening when the housing is secured thereto.

8. The window pet enclosure of claim 1, further comprising a shade disposed about a roller on an upper end of at least one sidewall of the plurality of sidewalk, wherein the shade is selectively movable between an extended position extending along a height of the sidewall and a retracted position about the roller.

9. The window pet enclosure of claim 8, wherein the roller is spring-biased to automatically retract the shade, such that the shade is biased towards the retracted position.

10. The window pet enclosure of claim 1, further comprising a plurality of accessories removably securable within the housing, wherein the plurality of accessories is selected from a group consisting of: a staircase, a ramp, and a litter box.

11. A window pet enclosure, comprising:
a housing having a base;
a frame extending from the base, wherein the frame comprises a plurality of supports affixed to each corner of the base;
wherein each of the plurality of supports comprises a plurality of interlocking legs, wherein each of the plurality of interlocking legs includes at least one tab and at least one aperture therein;
wherein the aperture is dimensioned to frictionally engage the tab to secure the plurality of interlocking legs together to define a variety of housing interior configurations;
an upper wall affixed to a distal end of each of the plurality of supports;
a plurality of sidewalk disposed between the plurality of supports;
an opening defined through a rear sidewall of the plurality of sidewalk;
a mounting bracket disposed on the frame adjacent to the rear sidewall; and
wherein the housing is removably securable to an exterior of a window opening via the mounting bracket.

12. The window pet enclosure of claim 11, further comprising a plurality of shelves removably securable to the frame on an interior of the housing.

13. The window pet enclosure of claim 12, wherein the plurality of shelves includes a fastener on a rear side thereof, wherein the fastener is removably securable within a securement aperture disposed through the plurality of supports.

14. The window pet enclosure of claim 12, further comprising a rope affixed to a lower side of at least one of the plurality of shelves.

15. The window pet enclosure of claim 11, further comprising a door pivotally affixed to the base, wherein the door provides access to an interior of the housing through a lateral sidewall of the plurality of sidewalk.

16. The window pet enclosure of claim 11, wherein the plurality of sidewalls comprises a mesh material.

17. The window pet enclosure of claim 11, wherein the opening is disposed through the rear sidewall in an elevated position relative to the base, such that the base is disposed below a plane of the window opening when the housing is secured thereto.

18. The window pet enclosure of claim 11, further comprising a shade disposed about a roller on an upper end of at least one sidewall of the plurality of sidewalls, wherein the shade is selectively movable between an extended position extending along a height of the sidewall and a retracted position about the roller.

19. The window pet enclosure of claim 18, wherein the roller is spring-biased to automatically retract the shade, such that the shade is biased towards the retracted position.

20. The window pet enclosure of claim 11, further comprising a plurality of accessories removably securable within the housing, wherein the plurality of accessories is selected from a group consisting of: a staircase, a ramp, and a litter box.
